(19) United States
(12) Patent Application Publication
(10) Pub. No.: US 2026/0257439 A1
(43) Pub. Date: Sep. 3, 2026

(54) PROCESS FOR PARTIALLY ENCAPSULATING EYEGLASS FRAME COMPONENTS AND FRAME COMPONENT OBTAINED BY SUCH A PROCESS

(71) Applicant: LUXOTTICA S.R.L., Agordo (BL) (IT)

(72) Inventors: Gianluca FANDELLA, Belluno (BL) (IT); Silvio TIBOLLA, Belluno (BL) (IT)

(21) Appl. No.: 18/871,447

(22) PCT Filed: Jun. 8, 2023
(86) PCT No.: PCT/IB2023/055913

§ 371 Date: Dec. 3, 2024

(30) Foreign Application Priority Data
Jun. 10, 2022 (IT) 102022000012353

(51) Int. Cl. B29D 12/02; G02C 5/00; G02C 5/14

(52) U.S. Cl. CPC B29D 12/02; G02C 5/008; G02C 5/14

(57) ABSTRACT

A process is described for partially coating a component (1) of an eyeglass frame, such as a temple or a front; the process comprises the steps of providing a first sheet (2) of polymeric material (20) and a second sheet of polymeric material; making at least one seat in the first sheet (2) of polymeric material, wherein the seat is shaped to house the component (1); covering a first portion (11) of the component (1) with an insulating element (3); placing the component (1) in the seat; placing the second sheet on the first sheet (2) wherein the component (1) is placed in the seat; permanently joining the two sheets where they are in contact with each other; removing the polymeric material (20) from the first portion (11) covered with the insulating element (3) of the component (1). The invention also relates to a component of an eyeglass frame obtained by said process, and to a frame comprising at least one of such components.

The present invention relates to a process for partially encapsulating a component of an eyeglass frame, such as a temple or front. The present invention also relates to the encapsulated component obtained by such a process and to the eyeglass frame comprising such a component.

The present invention is usefully employed for coating only certain portions of a frame component, for example for coating the final end of a temple. The coating of this portion, which rests on a wearer's ear, is known as the tip. In fact, temples are generally made of a metal or even polymer core, which is coated to make the portion of the temple that rests on the ear more comfortable, but also to decorate and customise it.

It is known to coat eyeglass frame temples entirely or portions of the temples to form the so-called temple tips.

For temples having a regular shape, i.e. straight temples, a known method for encapsulating the ends involves snap-fitting onto the temple an acetate cap, i.e. the tip, which has been previously holed to house the temple therein.

This method has the disadvantage that the acetate cap tends to slip off the temple.

It is also known to apply plastic ends to temples by the so-called hot core-shooting process.

This process involves the insertion in cellulose acetate of a temple core with a needle-shaped end, i.e. pointed end, which is heated to facilitate insertion.

Disadvantageously, the core-shooting process is only applicable to cores with pointed ends and, in addition, the step of heating the core is undesirable as it generates deformation and tension within the core.

The two methods mentioned above, in addition to the above-described disadvantages, have the additional limitation of not being applicable in the case of temples having particular shapes. Specifically, these methods cannot be used for temples having a non-constant cross-section, e.g. with one end enlarged relative to the temple body, or for temples with irregular shapes, such as curved.

In order to make the tip on temples of various shapes, it is known, for example, to injection-mould a thermoplastic polymer, such as nylon, propionate or acetate, directly over the portion of the temple to be covered.

In particular, it is known to inject such thermoplastic polymer in a single step, making the tip in a single shell, or to mould a first and second half-shell of thermoplastic polymer at two different times, thus forming two distinct half-shells that are joined together to encircle the temple. The second method of double-jet injection is, for example, disclosed in the Italian Patent No. 102019000005312.

A disadvantage in common to both single- and double-jet injection moulding variants is that the process, although simple and fast, is violent to the temple due to the high pressures at which the polymer is injected.

Moreover, precisely because of these pressures, keeping the temple in place during the injection step is difficult. For example, supporting beams are used to hold the temple in place, which, when removed, form uncoated areas of the temple. Such supporting beams also scratch the core.

Furthermore, in case of double-jet injection, the separation line between the two halves is subject to the formation of defects up to the detachment of the two halves from each other.

In order to form temple-tips, a well-known alternative to injection moulding is casting a thermosetting resin onto the temple. However, this method is complex as it requires dedicated equipment, such as a special mould. Moreover, such process generates burrs and other defects that must be removed. Another disadvantage of casting is that it requires a polymerisation step of the resin in an oven, which generates deformations within the temple.

To address these problems, a cellulose acetate encapsulation process was developed from two acetate sheets.

This process consists in placing a temple between two acetate sheets, which are then coupled. In particular, the two sheets are joined by high-frequency welding or by acetone, resulting in a single body in which the temple is embedded. This body is then cut and processed to remove exceeding material, such as by shaping, shimming, bending and tumbling.

Disadvantageously, such a process results in total encapsulation of the component. Consequently, in the event that the coating is only to be applied to a portion of the temple, i.e. the temple-tip, it may be necessary to remove part of the coating. However, this removal step is delicate and sometimes damages the temple, as it is difficult to remove the acetate from the temple.

The task underlying the present invention is to make available a process for partially coating a component of a frame, such as a temple or a front, which overcomes the drawbacks of the above-mentioned prior art. The task underlying the present invention is also to make available a component of a frame obtained by such a process, such as a temple or a front, and a frame comprising such a component, which is partially coated and less prone to defects than those of the above-mentioned prior art.

The object of the present invention is in particular to provide a process that minimises damage to the component itself and is simple and precise.

Another object of the present invention is to provide a process that may be adapted to different types of components, and to several shapes thereof.

The above-mentioned task, as well as the objects mentioned and others which will better appear later, are achieved by a process as recited in claim 1, by a component of a frame obtained by such a process, as recited in claim 9, and by a frame comprising such a component, as recited in claim 10.

Other features are provided in the dependent claims.

Further features and advantages will be more apparent from the description of preferred, but not exclusive, embodiments of a process for partially coating a component of an eyeglass frame, such as a temple or a front, certain steps of which are shown, for illustrative and non-limiting purposes, with the aid of the accompanying drawings wherein:

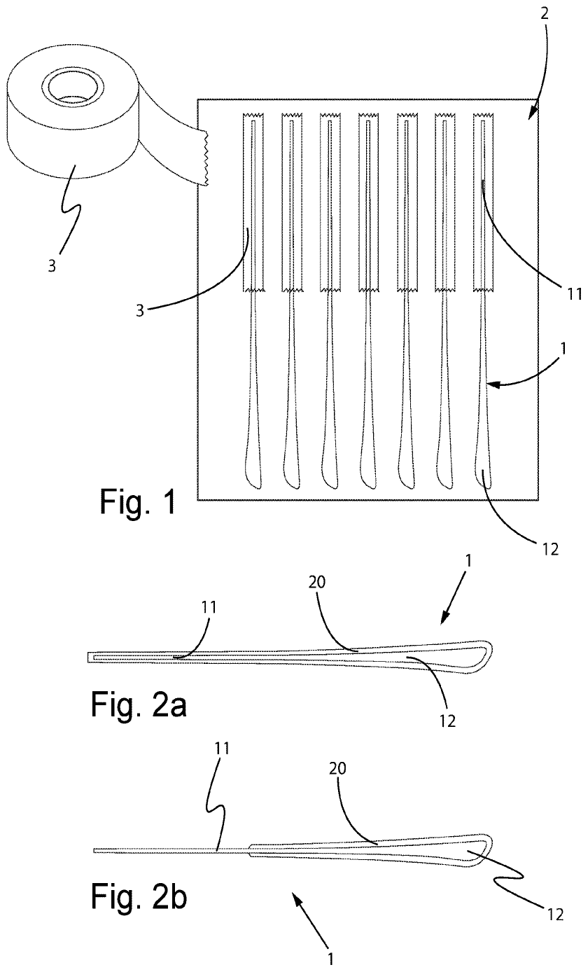

FIG. 1 shows a step of a process for partially coating an eyeglass frame component according to the present invention;

FIGS. 2a and 2b show temples of an eyeglass frame obtained by further process steps according to the present invention.

Referring to the attached figures, a process for partially coating a component 1 of an eyeglass frame is described hereinafter.

In the attached figures, the component 1 shown is a temple. However, the present invention also applies to other components of a frame, such as fronts.

In the following, reference is therefore made to a component 1 of an eyeglass frame, such as a temple or a front.

The component 1 comprises a first portion 11 which is not to be coated and a second portion 12 to be coated.

The process comprises a first step of providing a first sheet 2 of polymeric material 20 and a second sheet, not shown, of polymeric material. The second sheet is similar to the first sheet 2. In particular, the two sheets are preferably made of the same material and have similar dimensions, as explained hereinafter.

The polymeric material 20 of the sheets is preferably cellulose acetate or the like.

In particular, in the context of the present description, the polymeric material 20 of the sheets is given by any polymeric material that can be processed in sheet form, i.e. can be shaped and, at the same time, is not excessively brittle.

For example, the polymeric material 20 comprises acrylates or polyurethanes.

The sheets are preferably decorated with colours and/or patterns.

It is advantageously possible to obtain frame components 1 decorated in various ways, as shown hereinafter.

The step of providing a first and second sheet may possibly also comprise a sub-step of manufacturing such sheets by, for example, milling or laser cutting from a block of polymeric material 20.

The process comprises a further step of making at least one seat in the first sheet 2 of polymeric material 20. In particular, each seat is shaped to accommodate a component 1, to keep it still during the subsequent process steps.

Preferably the seat has a depth of at least 0.5 mm. More preferably, the seat has a depth of 1 mm.

One or more seats are preferably made by milling the first sheet 2.

It should be noted that one or more seats are made on at least one of the two sheets.

Accordingly, the seats can be made not only in the first sheet 2 but also in the second sheet.

Still preferably, the first sheet 2 has a plurality of seats to house a plurality of components 1, in order to increase production volumes.

Preferably, the first 2 and second sheet have the same lateral dimensions.

Always preferably, the first 2 and second sheet have a thickness of between 0.5 mm and 5 mm. More preferably, the two sheets have a thickness of between 1 mm and 4 mm.

The first sheet 2 and the second sheet may have an equal or different thickness.

Following the step of making at least one seat, the process comprises a step of placing the component 1 in the seat.

In the event that more than one seat are provided, this step involves placing a respective component 1 in each seat.

The process according to the present invention further comprises a step of covering a first portion 11 of the component 1 with an insulating element 3, as shown in FIG. 1.

This step may be carried out before or after the step of placing the component 1 in the seat.

After applying the insulating element 3 and placing the component 1 in the seat, the process comprises a step of placing the second sheet on top of the first sheet 2 wherein the component 1 is placed in the seat.

In particular, if the two sheets comprise both of the above-mentioned seats, the two sheets must be positioned so that the seats made on the first sheet 2 correspond to those made on the second sheet, in order to maintain a component 1 embedded between the two sheets.

In other words, the first sheet acts as the base while the second sheet acts as a lid.

The process preferably also comprises a step of arranging the two sheets in a mould. This step may be carried out at various times, such as before placing the second sheet on the first sheet 2 and after placing the component 1 in the respective seat, or before inserting the one or more components 1 in the seats of the first sheet 2, thus placing the second sheet directly in the mould when the step of placing the second sheet on the first sheet 2 is carried out.

The process then comprises a step of permanently joining the two sheets where they are in contact with each other.

Note in this regard that the insulating element 3 is, for example, an insulating tape, a heat-sealed bag or any other element that prevents, where present, the two sheets from being joined.

According to a preferred embodiment, the step of permanently joining the two sheets is carried out by high-frequency welding.

In this case, the insulating element 3 must therefore also be resistant to high-frequency welding.

This results in a single body formed by the two sheets and incorporating said one or more components 1 to be encapsulated.

Thus, the process of the present invention comprises a further step of removing the polymeric material 20 of the sheets from the first portion 11 covered with the insulating element 3 of the component 1.

This step is carried out after the step of permanently joining the two sheets.

It should be noted that, thanks to the present invention, and in particular to the fact that the first portion 11 of the component 1 is covered with the insulating element 3, the removal of the polymeric material 20 from the first portion 11 is easy.

In particular, the removal of exceeding polymeric material 20 is carried out in several steps.

For example, if several components 1 are embedded between the two sheets, they are separated from each other.

Processes such as laser cutting, shaping, shimming, tumbling, bending or even more are also provided to shape and/or remove part of the polymeric material 20 surrounding the component 1.

The shaping process, for example, makes it possible to obtain a wide variety of shapes very easily.

FIG. 2a shows, for example, a component 1 with a semi-finished coating, surrounding both the first portion 11 and the second portion 12.

Finally, according to a first embodiment, the process comprises a step of removing the insulating element 3 from the component 1.

This step is carried out after the removal of polymeric material 20 from the component 1.

According to a second embodiment, the step of removing the insulating element 3 from the component 1 is not provided. In fact, according to the second embodiment, the insulating element 3 remains intimately bonded to the polymeric material 20, without having to remove it from the component 1.

Advantageously, the component 1 remains protected until the end of the process: this allows to encapsulate finished components 1 minimising the risk of damaging them, and without having to further process at the end of the process.

At the end of the process, the component 1 is finished and coated only at the second portion 12, as shown in FIG. 2b.

The present invention also relates to a component 1 of an eyeglass frame obtained by such a process. Such a component 1 is a temple and/or front comprising a first uncoated portion 11 and a second portion 12 coated with polymeric material 20 by the process described above, visible in FIG. 2b. In particular, this second portion 12 preferably has a curved or irregular shape.

Preferably, this second portion 12 is coated with cellulose acetate by means of the process described above.

Advantageously, a component 1 is obtained that is partly uncoated and partly coated.

For example, the component 1 is a metal temple with acetate tips at the ends, or a metal temple coated with acetate except at the end.

Or, the component 1 is either a metal front with a bridge, i.e. the connecting portion between the two lenses, coated in acetate or a front completely coated in acetate except for the bridge. Advantageously, it is also possible to cover bridges with different shapes, e.g. double.

The present invention also relates to an eyeglass frame, not shown in the accompanying figures, comprising at least one component 1 having a first uncoated portion 11 and a second portion 12 coated with a polymeric material by means of the process described above.

The process for coating eyeglass frame components thus conceived, as well as the component 1 obtained by such a process and the eyeglass frame comprising such a component, are susceptible to numerous modifications and variations, all of which fall within the scope of the inventive concept; moreover, all details are replaceable by technically equivalent elements. In practice, the materials used, as long as they are compatible with the specific use, as well as the dimensions and the contingent shapes, may be any according to the technical requirements.

1) Process for partially coating a component (1) of an eyeglass frame, such as a temple or a front or both, said process comprising the steps of:
providing a first sheet (2) of polymeric material (20) and a second sheet of polymeric material;
making at least one seat in said first sheet (2) of polymeric material (20), said seat being shaped to house said component (1);
covering a first portion (11) of said component (1) with an insulating element (3);
placing said component (1) in said seat;
placing said second sheet on said first sheet (2) in which said component (1) is placed in said seat;
permanently joining the two sheets where they are in contact with each other;
removing the polymeric material (20) of said sheets from the first portion (11) covered with said insulating element (3) of said component (1).

2) Process according to claim 1, comprising a further step of removing the insulating element (3) from the component (1).

3) Process according to claim 1, wherein said insulating element (3) remains intimately bonded to the polymeric material (20) without the need for removal from the component (1).

4) Process according to claim 1, wherein said step of permanently joining the two sheets is carried out by high-frequency welding.

5) Process according to claim 1, wherein said one or more seats are made by milling the first sheet (2).

6) Process according to claim 1, wherein said polymeric material (20) of said sheets is cellulose acetate or the like.

7) Process according to claim 1, wherein said first (2) and second sheets have the same lateral dimensions.

8) Process according to claim 7, wherein said first (2) and second sheets have equal or different thicknesses.

9) Component (1) of eyeglass frame, said component (1) being a temple and/or a front, said component (1) comprising:
a first uncoated portion (11);
a second portion (12) having a curved or irregular shape, said second portion (12) being coated with polymeric material (20) by the process according to claim 1.

10) Eyeglass frame comprising at least one component (1) according to claim 9.
